(19) United States
(12) Patent Application Publication
(10) Pub. No.: US 2007/0140076 A1
(43) Pub. Date: Jun. 21, 2007

(54) Method and apparatus for writing optically readable data onto an optical data

(75) Inventor: Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/576,315

(22) PCT Filed: Oct. 11, 2004
(86) PCT No.: PCT/IB04/03356

§ 371 Date: Apr. 18, 2006

(30) Foreign Application Priority Data
Oct. 20, 2003 (EP) 03300169.4

(51) Int. Cl. G11B 7/00

(52) U.S. Cl. 369/44.29

(57) ABSTRACT

The invention relates to an apparatus (20) for reading data from and/or writing data onto an optical data carrier (21) is proposed. An optical source generates an incident beam (26), an objective lens assembly (28) focuses the incident beam onto the optical data carrier. A thin convex lens (32) without substantial astigmatism is used for projecting the returning beam (30) onto an optical detection assembly (33) for generating a tracking error signal. An optical data carrier has a recording layer, onto which optically readable data is written in the form of binary marks or pits (11). The binary marks are capable of causing a phase difference which lies close to 180° between reflected light which has interacted with said binary marks and reflected light which has interacted with the rest of the recording layer. The signal to noise ratio of data signal and tracking error signal are improved at the same time.

### FIELD OF THE INVENTION

The present invention relates to an apparatus for reading data from and/or writing data onto an optical data carrier. The present invention also relates to a method of writing optically readable data onto an optical data carrier and to an optical data carrier which carries optically readable data obtainable with the method.

The invention applies to all types of optical data carriers, including Compact Discs, Digital Versatile Discs, and Blu-ray Discs, and to the corresponding apparatuses for reading and/or writing data

### BACKGROUND OF THE INVENTION

The prior art, such as US-A-20030081530, discloses optical pickups in which a light beam reflected from an optical disc is converged by a detection lens and passes through an element for producing astigmatism, such as a cylindrical lens, before reaching a light-receiving surface of an optical detector. The optical detector is connected to a demodulation circuit for producing a recordation or data signal and to an error detection circuit for generating a focus error signal, a tracking error signal, and other servo signals.

### SUMMARY OF THE INVENTION

It is an object of the invention to improve the signal-to-noise ratio (SNR) of such signals, especially data signal and tracking error signal, in order to minimize the rate of errors when reading data from and/or writing data onto an optical data carrier.

According to the invention, this object is achieved by an apparatus as stated in claim 1, a method as stated in claim 6 and an optical data carrier as stated in claim 10.

The invention is based on the recognition of a problem, that arises in optical pickups of the prior art, namely a conflict between the SNR of the data signal and the SNR of the tracking error signal. This problem will be shown in more detail with reference to FIGS. 1, 2 and 3.

FIG. 1 is a schematic representation of an optical pickup of the prior art, where, for convenience, the reflective system is represented as a transmittive system with identical apertures at the entrance pupil and at the exit pupil, which correspond to the same objective lens assembly in reality. For reading data, a laser beam 6 is focused by the objective lens assembly 1 on a recording layer of the optical disc 3. With the help of a servo system, the laser spot can stay focused and scan the recorded marks along the track. The binary information represented by the marks is read out through detection of the intensity variation of the reflected laser beam 7 that is projected onto optical detector 4 through astigmatic lens 5.

The binary marks are pits in ROM format discs and phase-changed areas in rewritable R(W) format discs. FIG. 2 is a schematic cross-sectional view of the disc 3 showing a portion of the track in the case of a ROM format disc. The disc 3 includes a transparent polycarbonate substrate layer 8. The binary marks are pits 11 with height d which are molded into the substrate layer 8 from the inner surface thereof. A reflective aluminum layer 9 is then applied in a sputtering process and conforms to the molded polycarbonate substrate 8. A protection layer 10 covers the reflective layer 9.

FIG. 3 is a perspective cross-sectional view taken in the plane III-III of FIG. 2, showing a portion of the ROM disc 3. The incident beam 6 enters the disc through substrate layer 8 and is reflected by reflective aluminum layer 9. Incident rays 6a which impinge on a data pit 11 are reflected at a different depth from rays 6b, which impinge on the rest of substrate layer 8, i.e. the so-called land 12. In ROM discs, the pit-land structure can be regarded as a two-dimensional phase grating. The phase difference ψ between reflected rays 7b and 7a satisfies ψ=4πnd/λ with n the refractive index of substrate layer 8.

Reverting to FIG. 1, the parallel laser beam 6 fills the entrance pupil plane (x,y) and is focused onto the recording layer of the disc 3. Being reflected, it propagates and arrives at the exit pupil (x′, y′). Because of the diffraction, only part of the light goes back through objective lens assembly 1 and gets projected on photo detector 4 through astigmatic lens 5. According to diffraction theory, with the presence of strong astigmatism, the light field on photo detector 4 will reveal the astigmatism of the exit pupil plane (x′, y′), thus extracting a data signal and tracking error signal from photo detector 4 is equivalent to doing so directly from the exit pupil of the objective lens assembly 1. Now, the light field A(x′,y′) on the exit pupil is substantially:
A(x′,y′)=A(x,y)*F{R(u,v)}C(x′,y′) (1)
where * denotes a convolution and F{ } represents Fourier transform. Since the entrance and exit pupil planes are identical and since the incident beam is uniform, the entrance and exit pupil functions are A(x,y)=1 (x²+y²≦r²) and C(x′,y′)=1 (x′²+y′²≦r²), where r is the radius of objective lens assembly 1.
R(u,v) is the disc reflection function that can be expressed as:

$$R ( u , v ) = 1 + ( {ⅇ}^{j ψ} - 1 ) {\sum }_{i} {W}_{p} ( u - {u}_{i} , v - {v}_{i} ) \qquad ( 2 )$$
where the window function Wₚ(u-uᵢ, v-vᵢ) corresponds to a pit i centred at coordinates (uᵢ, vᵢ) with a phase modulation e^{jψ}.
The data signal I can be produced by integrating the light intensity on the photo detector 4:

$$\begin{matrix}I ( t ) = {\sum }_{i = 1}^{4} I ( {Q}_{i} ) \\ = {\int }_{- r}^{r} {\int }_{- r}^{r} {\vert A ( {x}^{′} , {y}^{′} ) \vert}^{2} ⅆ {x}^{′} ⅆ {y}^{′} \\ = {\int }_{- r}^{r} {\int }_{- r}^{r} {\vert A ( x , y ) * F \{ R ( u , v ) \} \vert}^{2} ⅆ x ⅆ y\end{matrix} \qquad ( 3 )$$

where Qᵢ denotes the quadrants of a conventional 4-quadrant detector.

For simplicity, it is assumed an identical period p and an identical pit width w in both radial direction v and tangential direction u, as shown in FIG. 3. Also, we assume that the pit windows are ideally of a rectangular shape and with infinitely steep walls. We have the following approximation:

$$A ( x , y ) * F \{ R ( u , v ) \} \approx \{ \begin{matrix}A ( x , y ) * [ \begin{matrix}δ ( x , y ) + \\ ( {ⅇ}^{ j ψ} - 1 ) {ⅇ}^{ j ϕ} {W}_{ p} ( x , y )\end{matrix} ] , x ∈ [ 0 , r ] \\ A ( x , y ) * [ \begin{matrix}δ ( x , y ) + \\ ( {ⅇ}^{j ψ} - 1 ) {ⅇ}^{ - j ϕ} {W}_{p} ( x , y )\end{matrix} ] , x ∈ [ - r , 0 ]\end{matrix} \qquad ( 4 )$$

where Wₚ(x,y) represents the Fourier transform of the periodic pit window structure Wₚ(u,v) including all pit windows Wₚ(u-uᵢ,v-vᵢ), i.e. a 2-dimentional square wave. φ=2πst/p represents the phase shift of the spot position, where the laser spot is assumed to scan the track along the tangential direction u at a speed s, as shown by arrow 13. Note that only the first order harmonic is taken into account.
Using the axial symmetry and realness of the functions Wₚ(x,y) and A(x,y), it is obtained:

$$I ( t ) = 2 ( cos ψ - 1 ) {\int }_{0}^{r} {\int }_{- r}^{r} \{ \begin{matrix}2 cos ϕ [ {W}_{p} ( x , y ) * A ( x , y ) ] - \\ {\vert {W}_{p} ( x , y ) * A ( x , y ) \vert}^{2}\end{matrix} \} ⅆ x ⅆ y \qquad ( 5 )$$

where the irrelevant DC component is omitted.

It is clear that the factor 2(cos ψ-1) determines the modulation amplitude of the data signal. The modulation amplitude increases as the pit height d increases, which corresponds to the increase of the phase difference ψ. The maximum modulation is achieved when the phase difference ψ reaches π radians, i.e. 180°, meaning the light reflected by a pit 11 is in anti-phase with the light reflected by the land 12, and a maximum extinction of the reflected beam 7 is obtained.

Furthermore, the tracking error signal TES, which is needed to keep the focused laser spot steady on the desired track during reading or writing, is traditionally generated from a so-called radial push-pull channel. Refering to FIG. 3, if the spot of laser beam 6 hangs over one of the pits 11, having no shift in the tangential direction u while having a deviation (i.e. an off-track) l in the radial direction v, the corresponding tracking error signal can be obtained by:

$$\begin{matrix}TES ( l ) = I ( {Q}_{1} ) + I ( {Q}_{2} ) - I ( {Q}_{3} ) - I ( {Q}_{4} ) \\ = {\int }_{- r}^{r} {\int }_{0}^{r} [ {\vert A ( {x}^{′} , {y}^{′} ) \vert}^{2} - {\vert A ( {x}^{′} , - {y}^{′} ) \vert}^{2} ] ⅆ {x}^{′} ⅆ {y}^{′}\end{matrix} \qquad ( 6 )$$

Substituting Eqs. (1) and (2) into Eq. (6) and following the outline of the data signal derivation above, we obtain:

$$\begin{matrix}TES ( l ) = {\int }_{- r}^{r} {\int }_{o}^{r} 2 Re \{ \begin{matrix}( {ⅇ}^{j ψ} - 1 ) ( {ⅇ}^{j ϕ} - {ⅇ}^{- j ϕ} ) \\ [ {W}_{p} ( x , y ) * A ( x , y ) ]\end{matrix} \} ⅆ x ⅆ y \\ = - 4 sin ψ {\int }_{- r}^{r} {\int }_{0}^{r} sin ϕ [ {W}_{p} ( x , y ) * A ( x , y ) ] ⅆ x ⅆ y\end{matrix} \qquad ( 7 )$$

where φ=2πl/p. It can be seen that the amplitude of the tracking error signal TES is maximized when ψ reaches π/2 and then decreases till reaching the zero amplitude when ψ reaches π.

Thus, with the prior art optical pickup, the conflict between maximizing data signal amplitude and tracking error signal amplitude is such that the tracking error signal TES will be completely lost (sin π=0) if one tends to achieve maximum data signal amplitude. In other words, the modulation depth of the data signal has to be limited due to the requirement of a tracking error signal having sufficient amplitude. Hence, the highest modulation depth which is used corresponds to ψ=135°.

Having recognized the above conflict, a basic idea of the invention is to suppress all substantial astigmatism from the optical system which leads the reflected beam to the optical detection assembly that serves to generate a tracking error signal, i.e. at least two photo detectors for generating intensity signals corresponding to at least two cross-sectional portions of the reflected beam. This measure suppresses the conflict between data signal amplitude and tracking error signal amplitude. Hence, the amplitudes of both signals can be increased or even maximized at the same time, which results in an improvement of the SNR of both signals.

The measure as defined in claim 2 has the advantage that a thin convex lens, i.e. a normal imaging lens, is used for converging the reflected beam onto the optical detectors. Such a lens is advantageous in terms of quality-price ratio.

The measure as defined in claim 3 provides a separate optical branch for the purpose of focus error signal generation. Hence, any method of focus error signal generation can be used without disturbing the tracking error signal generation. The data signal can be detected in either branch.

Tracking error signals of different types, such as those defined in claims 4 and 5, especially radial push-pull signals and differential push-pull signals and multi-beam tracking error signals, will benefit from the measures defined in claim 1.

The method as stated in claim 6 increases the modulation amplitude of the data signal, which results in an improved SNR. At the same time, this method also improves the modulation amplitude and SNR of a tracking error signal which is produced by an apparatus as stated in claim 1. The measure as defined in claim 7 provides substantially optimal modulation amplitude for both signals.

The method applies to several types of data carriers having different types of recording layers. For example, the ROM type optical disc has a recording layer which consists of a substrate layer having local variations in depth with respect to the outer surface of the disc. The substrate thickness is reduced at areas carrying a binary 1, i.e. so called data pits. The phase modulation of the reflected light can be brought to within the selected range by adjusting the depth of the data pits.

In the recordable, write-once optical discs (CD-R, DVD-R, DVD+R), the data-recording layer is an organic photosensitive dye. Binary marks are written to the dye by a chemical change caused by the laser light beam. The phase modulation of the reflected light can be brought to within the selected range by selecting an appropriate dye.

The data-recording layer of the rewritable optical disc (CD-RW, DVD-RW, DVD+RW, DVD-RAM) is a phase-changing metal alloy film. A laser beam writes binary marks to the film by heating the film and thereby inducing a phase change (crystallization). The phase modulation of the reflected light can be brought to within the selected range by adjusting pre-groove depth and recording layer reluctance at the binary marks.

These and other aspects of the invention will be apparent from and elucidated with reference to the embodiments described hereinafter, by way of example, with reference to the drawings.

### BRIEF DESCRIPTION OF THE DRAWINGS

FIG. 1 is a schematic representation of an optical pickup in accordance with the prior art,

FIG. 2 is a partial cross-sectional view of a ROM type optical disc,

FIG. 3 is a partial perspective view showing the recording layer of a ROM type optical disc,

FIG. 4 is a schematic representation of an apparatus in accordance with an embodiment of the invention,

FIG. 5 is a graph showing a radial push-pull signal obtainable with the apparatus of FIG. 4 as a function of an off-track of the optical beam, for several values of the data modulation depth,

FIG. 6 is a graph showing the SNR of a data signal obtainable with the apparatus of FIG. 4 as a function of the data modulation depth.

### DETAILED DESCRIPTION OF THE INVENTION

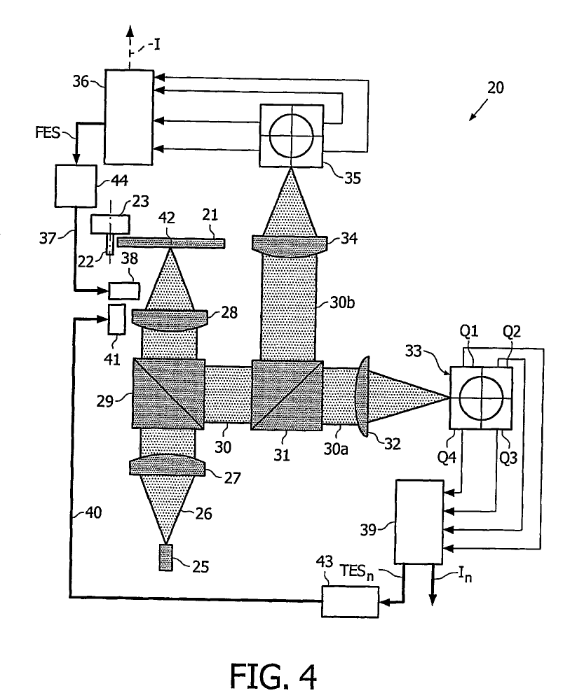

FIG. 4 shows an apparatus 20 for reading data from and writing data onto an optical disc 21. The schematic representation of FIG. 4 concentrates on the optical system of the apparatus 20, whereas the rest of the apparatus is conventional and need not be described in detail here. The optical system as shown is schematic. The optical disc 21 may be of any type. If the optical disc 21 is a ROM type, reference may be made to FIGS. 2 and 3. The optical disc 21 is rotated about a shaft 22 by a motor 23.

The optical system of the apparatus 20 comprises a laser source 25 which generates an incident beam 26, a collimator lens 27 which renders the incident beam 26 substantially parallel, an objective lens assembly 28 which focuses the beam 26 onto the recording layer of the disc 21, a first beam splitter 29 which separates the reflected beam 30 from the incident beam 26 (conventional polarization elements are not shown), and a second beam splitter 31 which splits the reflected beam 30 into a first branch 30a converged by a perfect lens 32 onto a first quadruple photo detector 33 and a second branch 30b converged by an astigmatic lens assembly 34 onto a second quadruple photo detector 35.

The astigmatic lens assembly 34 and second quadruple photo-detector 35 form part of a conventional astigmatic focus error detection system which further includes a focus error signal generation circuit 36. The focus error signal generation circuit 36 processes the intensity signals from the four quadrants of quadruple photo-detector 35 so as to produce a focus error signal FES that is passed on to a focus controller 44 for producing a control signal 37 for a focus actuator 38. The focus actuator 38 is capable of modifying the position of objective lens assembly 28 along the optical axis thereof.

However, any type of focus error detection system may be arranged on the second branch 30b instead of the astigmatic focus error detection system. For example, the well-known Foucault knife edge focus error detection systems are also appropriate.

The perfect lens 32 and quadruple photo detector 33 are part of a modified tracking error detection system which further includes a processing circuit 39 that processes the intensity signals from the four quadrants Q₁, Q₂, Q₃, Q₄ of quadruple photo detector 33 for generating a data signal Iₙ and a tracking error signal TESₙ, as will be explained below. The processing circuit 39 passes the tracking error signal TESₙ on to a tracking controller 43 which produces a control signal 40 for a radial tracking actuator 41 as a function of the tracking error signal TESₙ. The radial tracking actuator 41 is capable of modifying the position of objective lens assembly 28 transversely to the track in order to maintain the focusing spot 42 at the center of the track. The data signal Iₙ is fed to a demodulation circuit that need not be described in more detail here.

The perfect lens 32 is a convex imaging lens of a conventional design, i.e. thin and paraxial. Therefore, it does not have any substantial astigmatism. In other words, the root mean square value of the corresponding wave front aberrations is smaller than the diffraction limit of 0.07 λ, where is λ the wavelength. Thanks to the absence of astigmatism, as will be shown, the above-mentioned conflict between the data signal and tracking error signal amplitudes is suppressed.

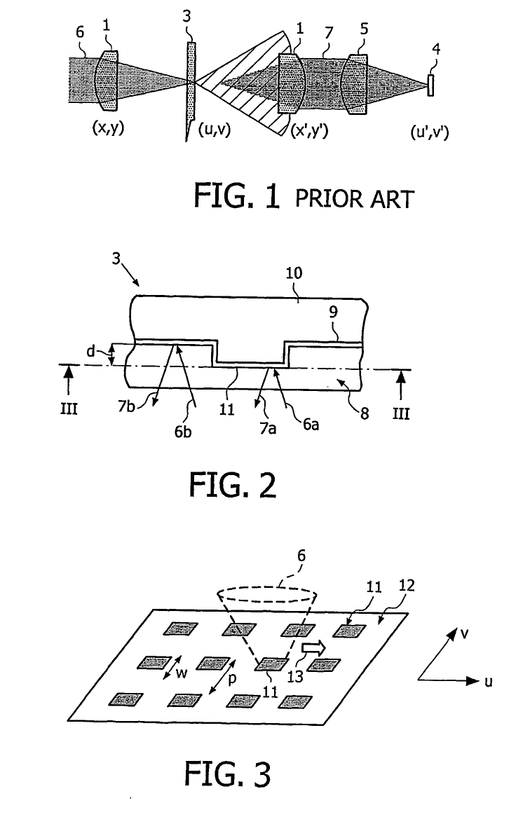

For the purpose of calculating the light intensity distribution on the quadruple photo detector 33, the beam splitters 29 and 31 need not be taken into account since they only introduce a uniform scaling factor. Hence, the light path of the reflected beam branch 30a almost resembles that of beam 7 in FIG. 1, except that, the light field on the exit pupil plane of the objective lens 28 is further imaged by the perfect lens 32 onto the detection plane. As is well known in the theory of Fourier optics, the effect of the perfect lens 32 is essentially a Fourier transform in the far field approximation. Thus, the light field A on the detection plane of photo detector 33, namely the plane (u′, v′), can be written as:
A(u′,v′)=[A(u,v)R(u,v)]*C(u′,v′) (8)
where A(u,v)=F¹[A(x,y)],
   C(u′,v′)=F¹[C(x′,y′)]
   F¹ denotes inverse Fourier transform—both have the form of a first-order Bessel function. In fact, they equal each other because A(x,y)=C(x′,y′).
      Using the assumption for the disc reflection function R(u,v) in (4) but translated into the disc plane (u,v), we have:
      A(u,v)R(u,v)≈A(u,v){1+(e^{Jψ}−1)[Wₚ(u,v)+ΔWₚ(u,v,l)]} (9)
where the window deviation ΔWₚ(u,v,l) corresponds to a radial offset l with respect to the center of the track.
Similarly to Eq. (7), the tracking error signal can be expressed as:

$$\begin{matrix}{TES}_{n} ( l ) = I ( {Q}_{1} ) + I ( {Q}_{2} ) - I ( {Q}_{3} ) - I ( {Q}_{4} ) \\ = {\int }_{- r}^{r} {\int }_{0}^{r} [ {\vert A ( {u}^{′} , {v}^{′} ) \vert}^{2} - {\vert A ( {u}^{′} , - {v}^{′} ) \vert}^{2} ] ⅆ {u}^{′} ⅆ {v}^{′}\end{matrix} \qquad ( 10 )$$

Substituting Eqs.(8) and (9) into Eq.(10), defining:
D(u,v)=[A(u,v)Wₚ(u,v)]*A(u,v)
ΔD(u,v)=[A(u,v)ΔWₚ(u,v,l)]*A(u,v)
and taking into account the realness of the functions A(u,v), D(u,v) and ΔD(u,v), it is obtained:

$${TES}_{ n} ( l ) = 2 ( cos ψ - 1 ) {\int }_{- r}^{r} {\int }_{0}^{r} \{ \begin{matrix}\begin{matrix}[ \begin{matrix}A ( u , v ) Δ D ( u , v ) - \\ A ( u , - v ) Δ D ( u , - v )\end{matrix} ] + \\ [ \begin{matrix}D ( u , v ) Δ D ( u , v ) - \\ D ( u , - v ) Δ D ( u , - v )\end{matrix} ] +\end{matrix} \\ [ {\vert Δ D ( u , v ) \vert}^{2} - {\vert Δ D ( u , - v ) \vert}^{2} ]\end{matrix} \} ⅆ u ⅆ v \qquad ( 11 )$$

In conclusion, the tracking error signal TESₙ varies as (cos ψ-1) in the apparatus 20.

Hence, the ψ-dependency of the tracking error signal TESₙ is identical to that of the data signal I obtained in the prior art apparatus, namely the modulation amplitude of both signals increases monotonically as ψ increases from 0 to π. This means that the SNR of both signals can be increased simultaneously if the data signal I is produced under similar conditions as in the prior art, i.e. with astigmatic lens 34 and detector 35. As is shown by a dashed arrow I in FIG. 4, it is possible to use the circuit 36 to produce the data signal I.

However, it is well known that a Fourier transform does not change the total intensity of a signal. Hence, in the case of the data signal Iₙ, which is produced after imaging of the reflected beam 30 by the perfect lens 32, the ψ-dependency of the data signal Iₙ is also a pre-factor (cos ψ-1), provided that the detector 33 collects the light leaving the entire exit cross-section of the objective lens assembly 28. This can be achieved by a proper choice of the magnification factor of lens 32 and the dimension of detector 33. Therefore, the conflict between the amplitudes of the data signal Iₙ and tracking error signal TESₙ is also removed when both data and tracking error signals are produced after the imaging of the reflected beam 30a by the perfect lens 32.

The above theoretical results have been confirmed with a computer simulation based on scalar diffraction theory. The simulation is done with DVD ROM parameters. The result is illustrated in FIG. 5. Each curve shows, for a different value of the phase difference ψ=4πnd/λ (i.e. for a corresponding value of the pit depth d) the variation of tracking error signal TESₙ as a function of the radial offset l. The abscissa is l/p, where p denotes the track pitch. The ordinate is TESₙin arbitrary units. It is clear that the maximum amplitude is achieved when ψ reaches π.

The noise in the data signal generally originates from defects on the data carrier, such as dust and scratches, and from electronic noise. Such a noise has no direct relation with the pit depth. Thus, in accordance with Eq.(5), the relative gain of data SNR can be written as:

$${G}_{SNR} ( ψ ) = 10 * {log}_{10} \frac{{( cos ψ - 1 )}^{2}}{4} \qquad ( 12 )$$

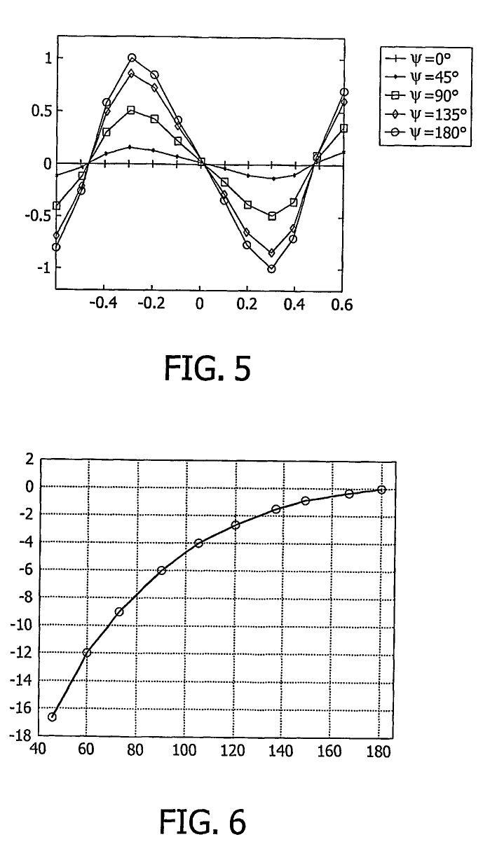

This relationship is illustrated in FIG. 6, where the abscissa is ψ in degrees and the ordinate is G_{SNR} in dB. For ψ=85°, where the prior art tracking error signal amplitude is almost optimal, the gain of data SNR is about −7 dB, which is very significant. For ψ=135°, which was suggested in the prior art as an acceptable trade-off between data signal and radial push-pull signal amplitudes, the gain of data SNR is still about −1.5 dB. It is clear that increasing the pit depth until the corresponding phase difference ψ gets closer to 7r results in an improvement of the data SNR. A similar trend is observed for the SNR of the tracking error signal TESₙ. Hence, in the apparatus 20, ROM discs having an increased pit depth d with respect to the prior art discs are read with an improved data signal SNR and tracking error signal SNR. Using the perfect lens 32 instead of an astigmatic lens assembly removes the conflict between increasing the data signal modulation and the availability of the tracking error signal. As a result, one can achieve maximum data modulation so as to gain a few dBs in the data signal to noise ratio.

In the above results, ψ refers to the phase difference which arises between light propagated through substrate layer 8 and reflected on a binary mark 11 and light propagated through substrate layer 8 and reflected on the land area 12. These results are not limited to ROM type discs. They apply to any other recording media in which the binary marks produce a phase difference, such as write-once optical discs and rewritable optical discs.

Systems using several reflected beams for radial tracking, such as the 3-spot systems described in EP-A-379285, can also benefit from the above method for removing the conflict between the amplitudes of the data and tracking error signals, thus optimizing the SNR of both signals. This stems from the fact that the multibeam push-pull signal for radial tracking is a linear combination of several one-beam push-pull signals.

As an alternative to the above signal TESₙ, the processing circuit 39 may produce a diagonal push-pull signal DPP for detecting the tracking error, namely:
DPP=[I(Q1)+I(Q3)]−[I(Q2)+I(Q4)] (13)

After a derivation similar to that of Eq. (11), one can observe that the signal DPP has the pre-factor (cos ψ-1) as well, which means that the signal DPP also takes maximum amplitude when the data signal modulation is maximized.

Although a simple embodiment of the apparatus 20 has been described above and represented in the drawings, more complex embodiments can be designed in that additional optical components are provided, such as aberrations compensators, polarizers, beam splitters and the like. Components which make the path of the returning light more ideal, such as aberrations compensators, render the actual light beam more similar to the assumptions on which the above derivations are based. Hence, such optical components can be used without adversely affecting the tracking error signal amplitude, provided that an imaging lens or lens group without substantial astigmatism serves to converge the reflected beam on the photodetectors provided for detecting the tracking error.

Although the above equations have been derived in the scalar approximation for the sake of clarity, proper accounting of the light polarization would not change the main result, namely that the tracking error signal and data signal have the same dependency on the phase difference ψ. Hence, polarization components may be added in the apparatus 20 without adversely affecting the tracking error signal amplitude.

A method of extracting a tracking error signal in an optical disc system has been described, in which the path of the reflected beam is modified by a perfect converging lens or lens group instead of an astigmatic lens assembly. The data signal and tracking error signal amplitudes are optimized at the same time by adjustment of the data modulation amplitude on the optical data carrier, in particular of ROM format.

The use of the verb “to comprise” or “to include” and its conjugations does not exclude the presence of elements or steps other than those stated in a claim. Furthermore, the use of the article “a” or “an” preceding an element or step does not exclude the presence of a plurality of such elements or steps.

In the claims, any reference signs placed between parentheses shall not be construed as limiting the scope of the claims.

1. An apparatus (20) for reading data from and/or writing data onto an optical data carrier (21), said apparatus comprising an optical source for generating an incident beam (26), an objective lens assembly (28) for focusing said incident beam onto said optical data carrier, and a detection lens assembly for projecting a returning beam (30), which returns from said optical data carrier, onto an optical detection assembly (33) suitable for the generation of a tracking error signal, said detection lens assembly being a converging lens assembly (32) without substantial astigmatism.

2. An apparatus as claimed in claim 1, wherein said detection lens assembly consists of a thin convex lens (32).

3. An apparatus as claimed in claim 1, further comprising a beam splitter (31) for splitting said returning beam into a first branch (30a) which is projected through said detection lens assembly and a second branch (30b) which is projected onto a focus error detection assembly of said apparatus.

4. An apparatus as claimed in claim 1, further including a tracking error signal generator (39) for generating a tracking error signal (TESₙ) which results from a difference between intensity signals corresponding to two cross-sectional portions of said returning beam.

5. An apparatus as claimed in claim 1, farther including a tracking error signal generator (39) for generating a tracking error signal, wherein said optical detection assembly includes four photo-detectors (Q₁-Q₄) arranged as a quadrilateral, and said tracking error signal results from a difference between two signals which are each obtained by adding the intensity signal of two diagonally opposed photo-detectors.

6. A method of writing optically readable data onto an optical data carrier (3) having a recording layer (8), said method comprising the step of locally modifying said recording layer for forming binary marks (11), said binary marks being capable of causing a phase difference between reflected light (7a) which has interacted with said binary marks and reflected light (7b) which has interacted with the rest of the recording layer, an amplitude (d) of said local modification being selected so as to bring said phase difference within a range [140°, 220°].

7. A method as claimed in claim 6, wherein the amplitude (d) of said local modification is selected so as to bring said phase difference within a range [170°, 190°].

8. A method as claimed in claim 6, wherein said local modification relates to the thickness of said recording layer.

9. A method as claimed in claim 6, wherein said local modification relates to a phase change of the material of said recording layer.

10. An optical data carrier having a recording layer (8), which carries optically readable data in the form of binary marks (11) which are capable of causing a phase difference lying within a range [140°, 220°] between reflected light (7a) which has interacted with said binary marks and reflected light (7b) which has interacted with the rest of the recording layer.
